(19) United States
(12) Patent Application Publication
(10) Pub. No.: US 2022/0119579 A1
(43) Pub. Date: Apr. 21, 2022

(54) PROCESS FOR PRODUCING POLYOXYMETHYLENE-POLYALKYLENE OXIDE BLOCK COPOLYMERS

(71) Applicant: Covestro Intellectual Property GmbH & Co. KG, Leverkusen (DE)

(72) Inventors: Markus Meuresch, Köln (DE); Aurel Wolf, Wülfrath (DE); Christoph Guertler, Köln (DE); Annika Stute, Köln (DE); Mike Schuetze, Leverkusen (DE)

(21) Appl. No.: 17/288,672

(22) PCT Filed: Nov. 14, 2019
(86) PCT No.: PCT/EP2019/081407

§ 371 Date: Apr. 26, 2021

(30) Foreign Application Priority Data
Nov. 22, 2018 (EP) 18207807.1

(51) Int. Cl. C08G 18/48; C08G 18/56; C08G 18/54; C08G 18/73; C08G 18/76; C08G 18/10; C08G 2/38; C08G 65/26; C08L 75/08

(52) U.S. Cl. CPC C08G 18/4825; C08G 18/56; C08G 18/546; C08G 18/73; C08G 18/7671; C08L 75/08; C08G 18/10; C08G 2/38; C08G 65/2663; C08G 65/2603; C08G 18/7621

(57) ABSTRACT

In a process for producing polyoxymethylene-polyalkylene oxide block copolymers comprising the step of polymerizing an alkylene oxide in the presence of an OH-terminated polyoxymethylene polymer and a catalyst, the polyoxymethylene polymer has a number-average molecular weight Mn determined after derivatization with propylene oxide and gel permeation chromatography against polystyrene standards with tetrahydrofuran as the eluent of ≥1100 g/mol to ≤2300 g/mol and the ratio of alkylene oxide to polyoxymethylene polymer is ≥0.05 mol/g. The invention further relates to copolymers obtainable by the process, to a process for producing polyurethane polymers using these copolymers and to polyurethanes obtainable therefrom.

The present invention relates to a process for producing polyoxymethylene-polyalkylene oxide block copolymers, comprising the step of polymerizing an alkylene oxide in the presence of an OH-terminated polyoxymethylene polymer and a catalyst. It further relates to copolymers obtainable by the process, to a process for producing polyurethane polymers using these copolymers and to polyurethanes obtainable therefrom.

Block copolymers containing polyoxymethylene units in addition to other polymer and polycondensate units are described, for example, in JP 2007 211082 A, WO 2004/096746 A1, GB 807589, EP 1 418 190 A1, U.S. Pat. Nos. 3,754,053, 3,575,930, US 2002/0016395 and JP 04-306215.

U.S. Pat. No. 3,575,930 describes the reaction of dihydroxy-terminated paraformaldehyde HO—(CH₂O)ₙ—H having n=2-64 with diisocyanates to give isocyanate-terminated polyoxymethylene polymers, which can be converted to polyurethane compounds in the reaction with diols.

JP 2007 211082 A describes the reaction of polyoxyalkylene polyols having an equivalent weight of >2500 with formaldehyde, formaldehyde oligomers or formaldehyde polymers to give polyoxymethylene-polyoxyalkylene block copolymers using anionic or cationic polymerization catalysts. The employed high molecular weight polyoxyalkylene polyol starters having low polydispersity are produced via double metal cyanide (DMC) catalysis. Because of the high molecular weight of the polyoxyalkylene polyols, the resultant polyoxymethylene-polyoxyalkylene block copolymers have a molecular weight of at least >5000 g/mol and are therefore less widely usable as a polyurethane unit.

Furthermore, the direct reaction of the polyoxyalkylene polyols with the polyoxymethylene polymers via a melt-kneading process necessitates the use of high temperatures and corresponding specific high-viscosity apparatus (extruders, kneaders, etc.).

U.S. Pat. No. 3,754,053 describes polyoxymethylene-polyoxyalkylene block copolymers having a molecular weight of >10 000 g/mol. Production of copolymers having an inner polyoxymethylene block comprises reacting trioxane to afford a polyoxymethylene prepolymer in a first step and then reacting the latter with alkylene oxides in the presence of for example NaOH as a polymerization catalyst. Here too, the polymers described are not very suitable for uses as a polyurethane unit because of their high molecular weight.

WO 2004/096746 A1 and US 2006/0205915 A1 disclose the reaction of formaldehyde oligomers with alkylene oxides and/or isocyanates. In this method the described use of formaldehyde oligomers HO—(CH₂O)ₙ—H affords polyoxymethylene block copolymers having a relatively narrow molar mass distribution of n=2-19, wherein an additional thermal removal process step is required for provision of the formaldehyde oligomers from aqueous formalin solution. The obtained formaldehyde oligomer solutions are not storage-stable and therefore require immediate subsequent further processing. Moreover, these applications do not disclose differentiated activation conditions, for example the activation temperature, the alkoxylation catalysts used, which are disadvantageous from safety and quality-relevant aspects among others for any possible industrial scale application because of undefined temperature peaks during the exothermic polymerization process (22.7 kcal/mol PO from M. Ionesco; Chemistry and Technology of Polyols for Polyurethanes, Rapra Techn. Ltd., 2005). Furthermore, only block copolymers having very short formaldehyde blocks are obtainable via this method.

EP 1 870 425 A1 discloses a process for producing polyoxyalkylene-containing polyols by condensation of substituted or unsubstituted phenol structures with formaldehydes and/or other substituted alkanal structures. The resulting phenol-formaldehyde condensates are used here as polyol starters for the alkoxylation, and no oxymethylene repeating units are formed within these starter compounds. In addition, the resulting properties of the alkoxylated, aromatics-containing polyols differ fundamentally from aliphatic polyol structures because of the different chemical structure.

WO 2012/091968 A1 claims a process for producing polyetherols by polymerization of alkylene oxides onto starter compounds using DMC catalysts. Disclosed here as formaldehyde-associated structures are oligomeric phenol-formaldehyde condensates as corresponding starters which are fundamentally structurally distinct from the polyoxymethylene starter structure.

Starting from the prior art, it was accordingly the object to provide a simple and economically advantageous process for preparing polyoxymethylene block copolymers based on oligomeric and polymeric forms of formaldehyde as the starter substance which can overcome the problems resulting from the prior art.

WO 2015/155094 A1 relates to a process for producing polyoxymethylene block copolymers by catalytic addition of alkylene oxides and optionally further comonomers onto at least one polymeric formaldehyde starter compound comprising at least one terminal hydroxyl group in the presence of a double metal cyanide (DMC) catalyst, wherein (i) in a first step the DMC catalyst is activated in the presence of the polymeric formaldehyde starter compound, wherein the DMC catalyst is activated by addition of a sub-amount (based on the entirety of the amount of alkylene oxides employed in the activation and polymerization) of one or more alkylene oxides, (ii) in a second step one or more alkylene oxides and optionally further comonomers are added to the mixture resulting from step (i), wherein the alkylene oxides employed in step (ii) may be identical or different from the alkylene oxides employed in step (i), characterized in that the activation of the DMC catalyst in the first step (i) is carried out at an activation temperature (T_{act}) of 20° C. to 120° C. However, this process results in a long activation time (t_{act}).

WO 2015/155094 A1 intimates that suitable polymeric formaldehyde starter compounds generally have molar masses of 62 to 30 000 g/mol, preferably of 62 to 12 000 g/mol, particularly preferably of 242 to 6000 g/mol and very particularly preferably of 242 to 3000 g/mol and comprise from 2 to 1000, preferably from 2 to 400, particularly preferably from 8 to 200 and very particularly preferably from 8 to 100 oxymethylene repeating units. However, production of the starter compounds is not described. The working examples employ commercially available paraformaldehyde.

It is an object of the present invention to provide polyoxymethylene-polyalkylene oxide block copolymers which are readily processable and have a higher proportion of formaldehyde compared to prior art block copolymers. It is a further object to reduce the activation time(t_{act}) of the DMC catalyst.

The object is achieved according to the invention by a process as claimed in claim 1, by a polyoxymethylene-polyalkylene oxide block copolymer as claimed in claim 11, by a process for producing a polyurethane polymer as claimed in claim 14 and by a polyurethane polymer as claimed in claim 15. Advantageous developments are specified in the dependent claims. They may be combined as desired unless the opposite is clear from the context.

In a process for producing polyoxymethylene-polyalkylene oxide block copolymers comprising the step of polymerizing an alkylene oxide in the presence of an OH-terminated polyoxymethylene polymer and a catalyst the polyoxymethylene polymer has a number-average molecular weight Mₙ

determined after derivatization with propylene oxide and gel permeation chromatography with tetrahydrofuran as eluent against polystyrene standards of ≥1100 g/mol to ≤2300 g/mol (preferably ≥1400 g/mol to ≤2100 g/mol) and the ratio of alkylene oxide to polyoxymethylene polymer is ≥0.05 mol/g.

It has now been found that the process according to the invention makes it possible to obtain block copolymer polyols which are advantageously further-processable to afford polyurethane polymers.

The block copolymers according to the invention are more cost-effective than the standard building blocks for polyols in PU applications. Their carbon footprint is also smaller, thus making it possible to provide more environmentally friendly building blocks for the PU market.

If, as in the case of double metal cyanide catalysts, activation of the catalyst is carried out prior to the actual polymerization by addition of an alkylene oxide, this alkylene oxide amount is also accounted for in the inventive ratio of alkylene oxide to polyoxymethylene polymer expressed in mol/g.

The polymerization of the alkylene oxide in the presence of the OH-terminated polyoxymethylene polymer and the catalyst is preferably performed at a temperature of ≥60° C. to ≤70° C.

The process according to the invention may generally employ alkylene oxides (epoxides) having 2-24 carbon atoms. The alkylene oxides having 2-24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C₁-C₂₄ esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkyoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane.—Preferably employed as alkylene oxides are ethylene oxide and/or propylene oxide, especially propylene oxide.

The polyoxymethylene polymers used, hereinbelow also referred to as “formaldehyde starter compound” or “pFA” may be described as polymers having an average chain length, i.e. having a number of formaldehyde units in the polymer between those of paraformaldehyde and those of the material POM. Such polymers are obtainable by a process described in the European patent application filed on Nov. 22, 2018 and having the application number EP18207740.

The molecular weight determination of the polyoxymethylene polymers to be employed cannot be carried out directly since they are insoluble in the commonly used eluents of gel permeation chromatography (GPC). On the contrary, an indirect method comprising a preceding derivatization with propylene oxide is chosen. The derivatized polymer which may also be a product of the process according to the invention is subjected to GPC against polystyrene standards and THF as eluent to determine the number-average molecular weight M_{n,product}. It is preferable when in the derivatization the weight ratio of propylene oxide to polyoxymethylene polymer is in a range from 2:1 to 4:1.

The molecular weight determination of the polyoxymethylene polymer employed as the reactant may then be calculated as follows having knowledge of the Mₙ from the GPC analysis of the product and the mass fractions of the reactants as the number-average molecular weight Mₙ of the polyoxymethylene polymer (“pFA”) (mₚFA: mass of the employed polyoxymethylene polymer; m_{PO}: mass of the employed propylene oxide):

M_{n,pFA}=(m_{pFA}/(m_{pFA}+m_{PO}))·M_{n,product}

The polyoxymethylene block copolymers obtainable by the process according to the invention preferably contain less than 2% by weight, especially less than 1% by weight, based on the total mass of the obtained polyoxymethylene block copolymer, of formate and/or methoxy impurities.

The use of the word “a” or “an” in connection with countable parameters should be understood here and hereinafter to mean the number one only when this is evident from the context (for example through the wording “precisely one”). Otherwise, expressions such as “an alkylene oxide”, “a polyoxymethylene polymer” etc. always also encompass embodiments in which two or more alkylene oxides, two or more polyoxymethylene polymers etc. are used.

In one embodiment the catalyst is a double metal cyanide catalyst. DMC catalysts for use in the homopolymerization of alkylene oxides that are suitable for the process according to the invention are known in principle from the prior art (see, for example, U.S. Pat. Nos. 3,404,109, 3,829,505, 3,941,849 and 5,158,922). DMC catalysts, described, for example, in U.S. Pat. No. 5,470,813, EP-A 700 949, EP-A 743 093, EP-A 761 708, WO 97/40086, WO 98/16310 and WO 00/47649, have very high activity in the polymerization of alkylene oxides and in some cases the copolymerization of alkylene oxides with suitable comonomers and they make it possible to produce polyoxymethylene copolymers at very low catalyst concentrations so that removal of the catalyst from the finished product is generally no longer required.

A typical example is that of the highly active DMC catalysts described in EP-A 700 949 which contain not only a double metal cyanide compound (e.g. zinc hexacyanocobaltate(III)) and an organic complex ligand (e.g. tert-butanol) but also a polyether having a number-average molecular weight greater than 500 g/mol.

The concentration of DMC catalyst employed is typically 10 to 10 000 ppm, preferably 20 to 5000 ppm and more preferably 50 to 2000 ppm based on the mass of the polyoxymethylene block copolymer to be produced. According to the profile of requirements for the downstream use the DMC catalyst can be left in the product or (partially) removed. The (partial) removal of the DMC catalyst can be effected, for example, by treatment with adsorbents and/or filtration. Processes for removing DMC catalysts are described, for example, in U.S. Pat. No. 4,987,271, DE-A-3132258, A-0 406 440, U.S. Pat. Nos. 5,391,722, 5,099,075, 4,721,818, 4,877,906 and EP-A-0 385 619.

In a further embodiment the ratio of alkylene oxide to polyoxymethylene polymer is moreover ≤0.1125 mol/g. The ratio is preferably in a range from ≥0.054 mol of alkylene oxide/g of polyoxymethylene polymer to ≤0.1 mol of alkylene oxide/g of polyoxymethylene polymer.

In a further embodiment the polyoxymethylene polymer has an average OH functionality of >1.9. The average OH functionality is preferably ≥2 to ≤3.

In a further embodiment a comonomer other than alkylene oxide is co-used in the reaction. Employable further comonomers include for example any oxygen-containing cyclic compounds, especially cyclic ethers, for example oxetane, THF, dioxane or cyclic acetals, for example 1,3-dioxolane or 1,3-dioxepane, cyclic esters, for example γ-butyrolactone, γ-valerolactone, ε-caprolactone, or cyclic acid anhydrides, for example maleic anhydride, glutaric anhydride or phthalic anhydride, and carbon dioxide. Preference is given to using carbon dioxide as a comonomer. This makes it possible to obtain polyoxymethylene-polyether carbonate block copolymers.

Compared to existing products (for example polyether polyols in the polyurethane sector or polyoxymethylene (co-)polymers in the POM sector) these additionally comprise CO₂ as an inexpensive and environmentally friendly comonomer. Since CO₂ is, inter alia, a waste product from energy generation from fossil raw materials and is being sent for further chemical utilization, the incorporation of CO₂ into the polymer structures provides not only economic but also environmental benefits (favorable CO₂ balance of the product polymers, etc.).

Polyoxymethylene-polyoxyalkylene carbonate block copolymers in the context of the invention refer to polymeric compounds containing at least one polyoxymethylene block and at least one polyoxyalkylene carbonate block. Polyoxymethylene-polyoxyalkylene carbonate block copolymers are of particular interest as feedstocks in the polyurethane sector and for applications in the polyoxymethylene (POM) sector. By altering the CO₂ content, the physical properties can be matched to the particular use, thus making it possible to develop new fields of application for these block copolymers.

The process according to the invention especially makes it possible to provide polyoxymethylene-polyoxyalkylene carbonate copolymers, wherein a high content of incorporated CO₂ is achieved and the products have a comparatively low polydispersity and contain a very low level of by-products and decomposition products of the polymeric formaldehyde.

In the production of the polyoxymethylene-polyoxyalkylene carbonate block copolymers with copolymerization of CO₂ as a comonomer it is preferable to use an excess of carbon dioxide based on the expected or estimated amount of carbon dioxide incorporated into the polyoxyalkylene carbonate block, since an excess of carbon dioxide is advantageous due to the inertness of carbon dioxide. The amount of carbon dioxide may be determined via the total pressure under the particular reaction conditions. A total (absolute) pressure in the range from 0.01 to 120 bar, preferably 0.1 to 110 bar, particularly preferably from 1 to 100 bar has proven advantageous for the copolymerization for producing the polyoxyalkylene carbonate block.

It has further been found for the process according to the invention that the copolymerization for producing the polyoxyalkylene carbonate block is advantageously performed at 50° C. to 150° C., preferably at 60° C. to 145° C., particularly preferably at 70° C. to 140° C. and very particularly preferably at 90° C. to 130° C. When temperatures are set to below 50° C. the reaction proceeds disproportionately slowly. At temperatures above 150° C. the amount of unwanted by-products rises significantly.

It should further be considered when selecting pressure and temperature that the CO₂ is ideally converted from the gaseous state into the liquid and/or supercritical fluid state. However, CO₂ may also be added to the reactor in solid form and then converted into the liquid and/or supercritical fluid state under the selected reaction conditions.

Carbon dioxide may be used in the gaseous, solid, liquid or supercritical state, preferably in the gaseous or solid state, particularly preferably in the gaseous state. When using carbon dioxide in the gaseous state, a partial carbon dioxide pressure of 1 to 73.8 bar, preferably of 1 to 60 bar, particularly preferably of 5 to 50 bar, is chosen. When using gaseous carbon dioxide the combination of pressure and temperature is chosen such that carbon dioxide in pure form is in the gaseous state under the chosen reaction conditions. The corresponding conditions are derivable from the phase diagram. After introduction into the reactor gaseous carbon dioxide partially or fully dissolves in the reaction mixture.

In a further embodiment the catalyst is a double metal cyanide catalyst (DMC catalyst) and:

(i) in a first step the DMC catalyst is activated in the presence of the polyoxymethylene polymer, wherein the DMC catalyst is activated by addition of a sub-amount (based on the entirety of the amount of alkylene oxide used in the activation and polymerization) of an alkylene oxide,
(ii) in a second step an alkylene oxide is added to the mixture resulting from step (i), wherein the alkylene oxide employed in step (ii) may be identical or different to the alkylene oxide employed in step (i) and
the activation of the DMC catalyst in the first step (i) is carried out at an activation temperature of ≥20° C. to ≤120° C.

Activation of the DMC catalyst may be accompanied by an evolution of heat, which may result in a temperature peak (“hotspot”), on account of an exothermic chemical reaction and a pressure drop in the reactor due to the conversion of alkylene oxide.

Without wishing to be bound to a particular theory it may be assumed that activation of the DMC catalyst (i) is accompanied by a conditioning of the formaldehyde starter compound, thus preventing formation of by-products and decomposition products (such as formates, methoxy derivatives and monomeric formaldehyde) and defragmentation of the polymeric formaldehyde into shorter chain lengths and simultaneously achieving sufficient activity and selectivity of the catalyst.

The step of activation of the DMC catalyst with the conditioning of the polymeric formaldehyde starter may be performed at mild temperatures. The conditioning of the formaldehyde starter compound in the presence of the DMC catalyst makes it possible for the starter to be reacted with alkylene oxides and optionally further comonomers in the subsequent polymerization step even at higher reaction temperatures without any further defragmentation and/or the formation of by-products and decomposition products.

A further advantage is that the conditioned formaldehyde starter compound usually has a substantially higher solubility after the conditioning, thus ensuring that only small amounts of further solvents and/or suspension media, if any, are required. It can further be ensured that an active DMC catalyst system for the polymerization is present, and a steadily progressing polymerization with continuous addition of the comonomers ensures a safe process and high product quality.

The activation of the DMC catalyst is therefore carried out in the presence of the polymeric formaldehyde starter compound. The starter compound and the DMC catalyst may optionally be suspended in a suspension medium. It is likewise also possible to use a further liquid starter compound (“co-starter”) in the mixture, the DMC catalyst and the polymeric formaldehyde starter compound being suspended therein. The DMC catalyst is activated at an activation temperature in the range from 20° C. to 120° C., preferably at 30° C. to 120° C., particularly preferably at 40° C. to 100° C. and very particularly preferably at 60° C. to 100° C.

The process is preferably performed such that the activation of the catalyst and the conditioning of the polymeric formaldehyde starter compound in step (β) are followed by a polymerization step (γ) with metered addition of one or more alkylene oxides. The process may in principle also be terminated after step (β) so that the conditioned polymeric formaldehyde starter compound then constitutes the end product of the process. Said compound generally has a high stability as a result of the conditioning according to the invention and if desired may be employed as an OH-functional unit for a very wide variety of consecutive reactions analogously to the polyoxymethylene block copolymer obtained from step (γ). In a further embodiment in the first step (i)

(α) a suspension medium or the polyoxymethylene polymer is initially charged and any water and/or other volatile compounds present are removed by elevated temperature and/or reduced pressure (“drying”), wherein the DMC catalyst is added to the polyoxymethylene polymer or to the suspension medium before or after the drying,
(β) the DMC catalyst is activated in the presence of the polyoxymethylene polymer by addition of a sub-amount (based on the entirety of the amount of alkylene oxides employed in the activation and polymerization) of alkylene oxide to the mixture resulting from step (α) and wherein the temperature peak (“hotspot”) occurring on account of the subsequent exothermic chemical reaction and/or a pressure drop in the reactor is then awaited in each case and wherein step (β) of activation may also be carried out two or more times, and in the second step (ii)
(γ) an alkylene oxide added to the mixture resulting from step (β), wherein alkylene oxide employed in step (γ) may be identical or different to alkylene oxide employed in step (β) and wherein at least in one of the steps (α) and (β) at least one polyoxymethylene polymer is added.

In a further embodiment step (γ) is performed at a temperature of ≥60° C. to ≤70° C.

In a further embodiment the suspension medium employed in step (α) is at least one compound selected from the group consisting of 4-methyl-2-oxo-1,3-dioxolane, 1,3-dioxolan-2-one, acetone, methyl ethyl ketone, acetonitrile, nitromethane, dimethyl sulfoxide, sulfolane, dimethylformamide, dimethylacetamide, N-methylpyrrolidone, dioxane, diethyl ether, methyl tert-butyl ether, tetrahydrofuran, ethyl acetate, butyl acetate, pentane, n-hexane, benzene, toluene, xylene, ethylbenzene, chloroform, chlorobenzene, dichlorobenzene, propylene carbonate and carbon tetrachloride.

In a further embodiment in step (α)

(α1) a suspension medium and the DMC catalyst are initially charged and water and/or other volatile compounds are removed by at least once pressurizing the mixture with >1 bar to ≤100 bar (absolute) of an inert gas at a temperature of ≥90° C. to ≤150° C. and in each case subsequently reducing the positive pressure to >1 bar to ≤20 bar (absolute) and in a subsequent step
(α2) the polyoxymethylene polymer is added to the mixture from step (α1).

The polymeric formaldehyde starter compound may be initially charged together with the DMC catalyst and the suspension medium in step (α), or added preferably after the drying, no later than in step (β).

The optionally employed suspension media generally contain no H-functional groups. Suitable suspension media are all polar aprotic, weakly polar aprotic and nonpolar aprotic solvents, containing no H-functional groups in each case. A mixture of two or more of these suspension media may also be employed as the suspension medium.

### Step (α) (Drying):

The addition of the individual components in step (α) may be carried out simultaneously or consecutively in any sequence.

It is preferable when in step (α) a suspension medium containing no H-functional groups is initially charged in the reactor. The amount of DMC catalyst required for the polyaddition, preferably in unactivated form, is added to the reactor subsequently. The sequence of addition is not critical. It is also possible to charge the reactor firstly with the DMC catalyst and subsequently with the suspension medium. It is alternatively also possible to suspend the DMC catalyst in the suspension medium first and to charge the reactor with the suspension subsequently. The suspension medium provides an adequate heat exchange area with the reactor wall or cooling elements installed in the reactor and the liberated heat of reaction can therefore be removed very efficiently. The suspension medium moreover provides heat capacity in the event of a cooling failure and the temperature may therefore be kept below the decomposition temperature of the reaction mixture in this case.

Alternatively, it is also possible in step (α) to initially charge in the reactor a suspension medium containing no H-functional groups and additionally a sub-amount of the polymeric formaldehyde starter compound and optionally DMC catalyst or it is also possible in step (a to initially charge in the reactor a sub-amount of the polymeric formaldehyde starter compound and optionally DMC catalyst. It is moreover also possible in step (α) to initially charge in the reactor the entirety of the polymeric formaldehyde starter compound and optionally DMC catalyst.

The polymeric formaldehyde starter compound may be fundamentally initially charged as a mixture with further polymeric formaldehyde starter compounds or other H-functional starter compounds. The process may be performed such that in step (α) a suspension medium, the polymeric formaldehyde starter compound and the DMC catalyst are initially charged and optionally water and/or other volatile compounds are removed by elevated temperature and/or reduced pressure (“drying”) or in an alternative embodiment of the step (α) is performed such that in a step (α1) a suspension medium and the DMC catalyst are initially charged and optionally water and/or other volatile compounds are removed by elevated temperature and/or reduced pressure (“drying”) and in a subsequent step (α2) the formaldehyde starter compound is added to the mixture from step (α1).

The addition of the polymeric formaldehyde starter compound may be carried out after cooling of the reaction mixture from step (α1), especially at room temperature, or the reaction mixture may already be brought to the temperature prevailing in subsequent step (β) and the addition carried out at this temperature. The formaldehyde starter compound is generally added under inert conditions. The DMC catalyst is preferably used in an amount such that the content of DMC catalyst in the resulting reaction product is 10 to 10 000 ppm, particularly preferably 20 to 5000 ppm and most preferably 50 to 2000 ppm.

In a preferred embodiment an inert gas (for example argon or nitrogen), an inert gas/carbon dioxide mixture or carbon dioxide is introduced into the resulting mixture of suspension medium and DMC catalyst and/or the polymeric formaldehyde starter compound while at the same time a reduced pressure (absolute) of 10 mbar to 800 mbar, particularly preferably of 50 mbar to 200 mbar, is applied.

In an alternative preferred embodiment the resulting mixture of DMC catalyst with suspension medium and/or the polymeric formaldehyde starter compound is pressurized at least once, preferably three times, with 1 bar to 100 bar (absolute), particularly preferably 3 bar to 50 bar (absolute), of an inert gas (for example argon or nitrogen), an inert gas/carbon dioxide mixture or carbon dioxide and the positive pressure is in each case subsequently reduced to about 1 bar to 20 bar (absolute).

The DMC catalyst may be added for example in solid form or in the form of a suspension in a suspension medium or two or more suspension media or—if the polymeric formaldehyde starter compound is in a liquid state of matter—as a suspension in a polymeric formaldehyde starter compound.

### Step (β) (Activation):

Step (β) serves to activate the DMC catalyst. This step may optionally be performed under an inert gas atmosphere, under an atmosphere of inert gas/carbon dioxide mixture or under a carbon dioxide atmosphere. Activation in the context of the present invention refers to a step in which a sub-amount of alkylene oxide is added to the DMC catalyst suspension at temperatures of 20° C. to 120° C. (“activation temperature”) and then the addition of the alkylene oxide is stopped, wherein due to a subsequent exothermic chemical reaction an evolution of heat, which can lead to a temperature spike (“hotspot”), is observed and due to the conversion of alkylene oxide and possibly CO₂ a pressure drop in the reactor is observed.

The alkylene oxide may be added in one step or in a stepwise addition in two or more sub-amounts. It is preferable when after addition of a sub-amount of alkylene oxide the addition of the alkylene oxide is interrupted until the evolution of heat occurs and the next sub-amount of alkylene oxide is added only then. For the process according to the invention it has further been found that the activation (step (β)) in the presence of the polymeric formaldehyde starter compound for production of the polyoxymethylene block copolymers is advantageously performed at an activation temperature of 20° C. to 120° C., preferably at 30° C. to 120° C., particularly preferably at 40° C. to 100° C. and very particularly preferably at 60° C. to 100° C. According to the invention the evolution of heat resulting from the chemical reaction in the activation of the DMC catalyst preferably does not lead to exceedance of a temperature of 120° C. in the reaction vessel. Below 20° C. the reaction proceeds only very slowly, and activation of the DMC catalyst takes a disproportionately long time or may not take place to the desired extent. At temperatures of 130° C. and higher, the amount of undesired by-products/decomposition products of polymeric formaldehyde starter compounds increases severely. Formation of formate and methoxy traces is observed for example. It has further been found to be an advantage of this embodiment that it is likewise possible to influence the properties of the polyoxymethylene block copolymer obtained, especially the length of the polyoxymethylene block, through precise adjustment of the parameters within this range.

The sub-amount of the alkylene oxide may optionally be added to the reaction mixture in a plurality of individual steps, optionally in the presence of CO₂, and the addition of the alkylene oxide then interrupted in each case. In this case the process step of activation comprises the period from the addition of the first sub-amount of alkylene oxide, optionally in the presence of CO₂, to the reaction mixture until occurrence of the evolution of heat after addition of the last sub-amount of alkylene oxide. The activation step may generally be preceded by a step for drying the DMC catalyst and optionally the polymeric formaldehyde starter compound at elevated temperature and/or reduced pressure, optionally while passing an inert gas through the reaction mixture, wherein this step of drying is not part of the activation step in the context of the present invention. Metered addition of one or more alkylene oxides (and optionally of the further comonomers, especially carbon dioxide) may in principle be carried out in different ways. Commencement of the metered addition may be carried out at the negative pressure or at a previously chosen supply pressure. The supply pressure is preferably established by introducing an inert gas (for example nitrogen or argon) or carbon dioxide, wherein the pressure (absolute) is 5 mbar to 100 bar, by preference 10 mbar to 50 bar and preferably 20 mbar to 50 bar.

Another alternative embodiment is a two-stage activation (step β), wherein

(β-I) in a first activation stage the addition of a first sub-amount of alkylene oxide is carried out under an inert gas atmosphere and
(β-II) in a second activation stage the addition of a second sub-amount of alkylene oxide is carried out under a carbon dioxide atmosphere.

### Step (γ) (Polymerization):

The metered addition of one or more alkylene oxides may be carried out simultaneously or sequentially via separate metered additions in each case or via one or more metered additions. If two or more alkylene oxides are used for synthesis of the polyoxymethylene block copolymers, the alkylene oxides may be metered in individually or as a mixture.

The three steps (α), (β) and (γ) may be performed in the same reactor or each separately in different reactors. Particularly preferred reactor types for the process according to the invention are stirred tanks, tubular reactors, and loop reactors. It is further also possible to use extruders, kneaders, etc. as preferred reactors for the process according to the invention. If the reaction steps α, β and γ are performed in different reactors a different reactor type may be used for each step. In the case of completely continuous reaction management the individual steps should preferably be spatially separate from one another, i.e. steps (α) and (β) spatially separate from (γ), so that separate temperature management and suitable gas introduction and application of negative pressure, addition of polymeric formaldehyde and metered addition of monomers in the individual steps is possible according to the invention.

The thermal and chemical stability of the polyoxymethylene block copolymers according to the invention/the product mixtures obtained from the process makes them particularly amenable to distillative workup. It is preferable to employ thin-film evaporators, strand evaporators and stripping columns and also combinations thereof to remove solvents or suspension media, volatile constituents and unreacted monomers and/or oligomers. However all other apparatuses for thermal distillative workup are also suitable in principle. This mode of workup may be carried out continuously or batchwise and also simultaneously with or subsequently to the reaction.

The invention likewise relates to a polyoxymethylene-polyoxyalkylene block copolymer obtainable by a process according to the invention. Said copolymers may be used for producing polyurethanes, washing and cleaning composition formulations, drilling fluids, fuel additives, ionic and nonionic surfactants, lubricants, process chemicals for paper or textile production or cosmetic formulations.

In one embodiment the polyoxymethylene-polyoxyalkylene oxide block copolymer has a viscosity at 20° C. determined according to DIN 51562 of ≥22 000 mPas to ≤26 000 mPas, preferably ≥23 000 mPas to ≤25 000 mPas. At 25° C. the viscosity is preferably ≥14 000 mPas to ≤18 000 mPas and more preferably ≥15 000 mPas to ≤17 000 mPas.

In a further embodiment the polymer is a polyoxymethylene-polyoxyalkylene carbonate block copolymer and comprises an inner polyoxymethylene block (“starter”) and at least one outer polyoxyalkylene carbonate block of formula:

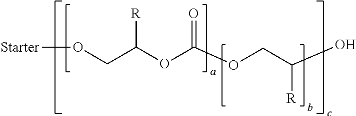

wherein R independently at each occurrence represents an organic radical, a, b and c represent an integer, R may differ in different repeating units, the structural unit “starter” represents a polyoxymethylene block deriving from the polyoxymethylene polymer and a, b and c are chosen such that the proportion of the “starter” accounts for ≤35% by weight, the proportion of structural units deriving from CO₂ accounts for ≤25% by weight and the proportion of structural units deriving from alkylene oxides accounts for the remainder to 100% by weight in each case based on the total weight of the polymer.

R may represent for example an organic radical such as alkyl, alkylaryl, arylalkyl or aryl, each of which may also contain heteroatoms, for example O, S, Si etc. Blocks having the recited structure in the obtained polyoxymethylene-polyoxyalkylene carbonate block copolymer may in principle conform to the above formula but the sequence, number and length of the blocks and also the OH functionality of the “starter” may vary and is not limited to the recited polyoxymethylene-polyoxyalkylene carbonate block copolymer.

A further aspect of the invention is a process for producing a polyurethane polymer comprising the step of reacting a polyisocyanate component with a polyol component, wherein the polyol component comprises apolyoxymethylene-polyalkylene oxide block copolymer according to the invention. Suitable polyisocyanates are for example TDI, MDI, polymeric MDI, H12-MDI, HDI, HDI isocyanurate (HDI trimer) and IPDI. Co-use of further polyols such as polyether polyols, polyester polyols or polyether ester polyols and additives such as blowing agents or fillers is likewise possible.

The invention likewise relates to a polyurethane polymer obtainable by a process according to the invention. Particular emphasis is given to polyurethane thermoplastics, polyurethane coatings, fibers, elastomers, adhesives and in particular also polyurethane foams, including flexible foams (for example flexible polyurethane block foams and flexible polyurethane molded foams) and rigid foams.

### EXAMPLES

The present invention is elucidated in detail by the examples and figures that follow, but without being restricted thereto.

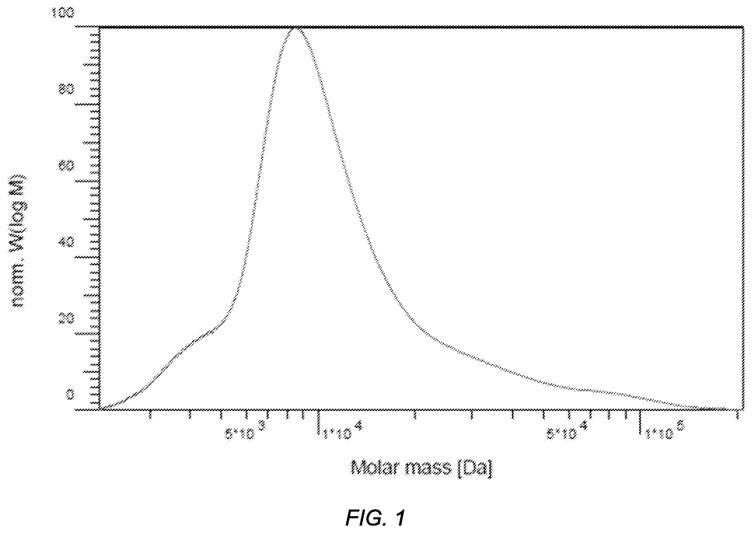

FIG. 1 shows a gel permeation chromatogram of a sample from example 1

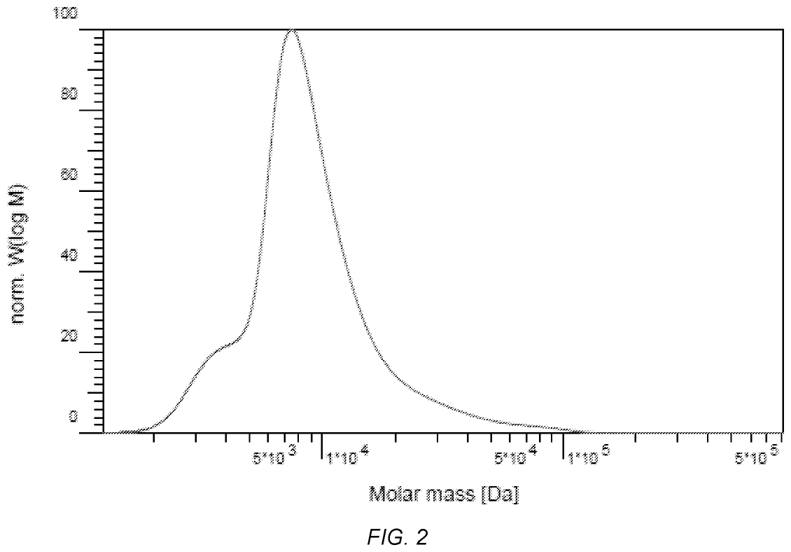

FIG. 2 shows a gel permeation chromatogram of a sample from example 2

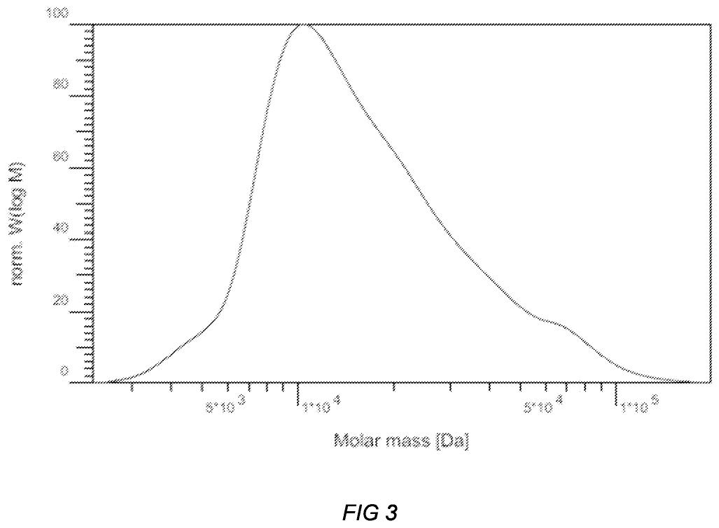

FIG. 3 shows a gel permeation chromatogram of a sample from example 3

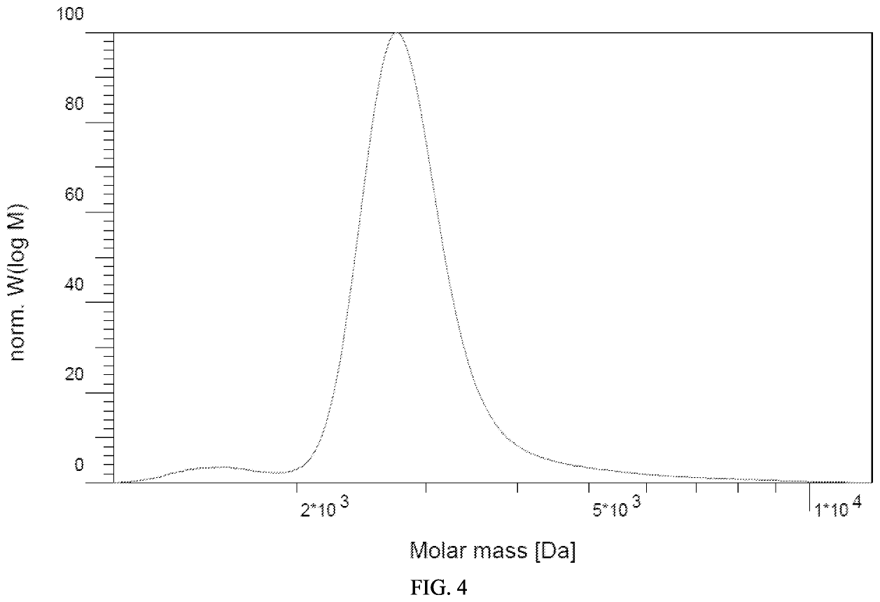

FIG. 4 shows a gel permeation chromatogram of a sample from counterexample 2

### GPC METHOD

The molecular weight determination of the block copolymers by gel permeation chromatography (GPC) was carried out using tetrahydrofuran (THF) as eluent against polystyrene standards. In addition the hydroxyl numbers (OHN) of the samples were determined according to DIN 53240 and the molecular weights of the block copolymers were calculated according to the formula MW=1000 mg/g·(F·56.106 g/mol)/OHN, wherein functionality F was assumed to be 2. Polydispersity indices PDI were calculated from M_{w}/Mₙ (GPC).

### NMR Method for Determining Polymer Composition:

The composition of the polymer were determined by ¹H NMR (Bruker DPX 400, 400 MHz; pulse program zg30, relaxation time D1: 10 s, 64 scans). Each sample was dissolved in deuterated chloroform. The relevant resonances in the ¹H NMR (based on TMS=0 ppm) and the assignment of the area integrals (A) are as follows:
cyclic propylene carbonate (cPC), solvent, resonance at 4.5 ppm, area integral corresponds to one hydrogen atom;
unreacted monomeric propylene oxide (PO), resonance at 2.4 and 2.75 ppm, area integral corresponds to one hydrogen atom in each case;
polypropylene oxide (PPO), PO homopolymer, resonances at 1.2 to 1.0 ppm, area integral corresponds to 3 hydrogen atoms;
poly- or paraformaldehyde (pFA) with resonances at 4.6 to 5.2 ppm, area integral minus one H atom of cyclic propylene carbonate (cPC) in each case;
formate (HCOO), by-product, resonance at 8.1 ppm, area integral corresponds to one hydrogen atom;
methoxy (MeO), trace by-product, resonance at 3.4 ppm.

Determination of the mole fractions (x) of the reaction mixture is carried out as follows:
x(cPC)=A(4.5 ppm)
x(P0)=A(2.75 ppm) or A(2.4 ppm)
x(PPO)=A(1.2-10 ppm)/3
x(pFA)=(A(4.6-5.2 ppm)-x(cPC)
x(HCOO)=A(8.1 ppm)

The composition of the reaction mixture thus determined is subsequently converted to parts by weight and normalized to 100. Conversion of the weight fractions uses the following molar masses (g/mol): cPC=102, PO and PPO=58, pFA=30 and HCOO=45. The polymer composition is calculated and normalized using the proportions of PPO and pFA so that here too the reported amounts are in parts by weight out of 100 (% by weight).

### Molar Mass of Paraformaldehyde Block:

The molar mass of the pFA block in the product polymer was calculated using gravimetric and NMR analytical methods performed according to the formulae below:
1) Determination by mass fraction: MW(pFA)=Mₙ(OHN)·(m(PFA)/(m(pFA)+m(PO)))
2) Determination by NMR: MW(pFA)=Mₙ(OHN)·(pFA proportion in polymer, NMR)/100
   wherein Mₙ(OHN) is the molecular weight MW determined by OH number titration (MW=56 100*2/OH number).

### Synthesis of Polyoxymethylene Polymer

This polymer was synthesized as described in the European patent application filed on Nov. 22, 2018 having the application number EP18207740. The polyoxymethylene polymer used in examples 1 and 2 was produced according to example 1 of EP18207740 and the polyoxymethylene polymer used in example 3 was produced according to example 2 of EP18207740.

### Example 1 (Inventive): Production of a Polyoxymethylene-Polyoxyalkylene Block Copolymer Using the Polyoxymethylene Polymer as Starter Material

In this example the mass ratio of propylene oxide to pFA starter excluding the propylene oxide used for catalyst activation was 200 g/50 g=4 g/g. Converted to the amount of substance of propylene oxide the ratio was 3.44 mol/50 g=0.069 mol/g. Including the propylene oxide (10 g) used for activation the ratios were 4.2 g/g and 0.072 mol/g.

500 mg of dried unactivated DMC catalyst were suspended in 200.0 g of 4-methyl-2-oxo-1,3-dioxolane (also referred to hereinafter as cyclic propylene carbonate or cPC) in a 1.0 L pressure reactor fitted with a gas introduction means. The suspension was heated to 130° C. with stirring (500 rpm). Simultaneously a vacuum was applied for 30 min and the pressure was set to 100 mbar with a constant volume flow of nitrogen through the reactor (vacuum stripping).

Once vacuum stripping was complete the pressure was adjusted to 5 bar with nitrogen and a pulse of propylene oxide (10 g) was added to the reaction solution. Activation of the catalyst was apparent from a temperature increase with a simultaneous pressure drop. The catalyst activation was followed by cooling of the reactor to room temperature and depressurization. 50.0 g of polyoxymethylene polymer (pFA) were added to the reactor and the reactor was re-sealed and purged by pressurization and depressurization with nitrogen. A pressure of 10 bar was then established with nitrogen. The reactor internal temperature was set to 70° C.

50 g of propylene oxide were quickly added to the suspension at an addition rate of 10 g/min (activation). Once addition was complete and after achievement of a constant pressure (time to) the mixture was left until an exothermic reaction in the reactor coupled with a simultaneous pressure drop (time ti) was observable. The time interval between addition (to) and onset of reaction (ti) is hereinbelow referred to as the activation time (t_{act}).

After the exothermic reaction had abated the reactor temperature was increased to 100° C. and the remaining amount of propylene oxide (150 g) was added at an addition rate of 3 g/min (semi-batch phase). Once addition was complete the mixture was stirred at 100° C. until the exothermic reaction had abated and until a constant pressure was achieved. The reactor was then cooled and the product withdrawn. The analytical data are reported in table 1. The molar mass distribution is shown in the GPC diagram of FIG. 1.

### Example 2 (Inventive): Production of a Polyoxymethylene-Polyoxyalkylene Block Copolymer Using the Polyoxymethylene Polymer as Starter Material

In this example the mass ratio of propylene oxide to pFA starter excluding the propylene oxide used for catalyst activation was 150 g/50 g=3 g/g. Converted to the amount of substance of propylene oxide the ratio was 2.57 mol/50 g=0.051 mol/g. Including the propylene oxide (10 g) used for activation the ratios were 3.2 g/g and 0.055 mol/g.

A polyoxymethylene-polyoxyalkylene block copolymer was produced according to example 1 but only 100 g of propylene oxide were supplied during the semi-batch phase. The molar mass distribution is shown in the GPC diagram of FIG. 2.

### Example 3 (Inventive): Production of a Polyoxymethylene-Polyoxyalkylene Block Copolymer Using the Polyoxymethylene Polymer as Starter Material

In this example a smaller amount of catalyst and a larger amount of propylene oxide compared to example 2 were used for catalyst activation. The propylene oxide metered addition amount was also different. The mass ratio of propylene oxide to PFA starter excluding the propylene oxide used for catalyst activation was 150 g/50 g=3 g/g. Converted to the amount of substance of propylene oxide the ratio was 3.44 mol/50 g=0.069 mol/g. Including the propylene oxide (20 g) used for activation the ratios were 3.4 g/g and 0.059 mol/g.

300 mg of dried unactivated DMC catalyst were suspended in 200.0 g of 4-methyl-2-oxo-1,3-dioxolane (also referred to hereinafter as cyclic propylene carbonate or cPC) in a 1.0 L pressure reactor fitted with a gas introduction means. The suspension was heated to 130° C. with stirring (500 rpm). Simultaneously a vacuum was applied for 30 min and the pressure was set to 100 mbar with a constant volume flow of nitrogen through the reactor (vacuum stripping).

Once vacuum stripping was complete the pressure was adjusted to 10 bar with nitrogen and a pulse of propylene oxide (10 g) was added to the reaction solution. The procedure was carried out twice in total. Activation of the catalyst was apparent from a temperature increase with a simultaneous pressure drop. The catalyst activation was followed by cooling of the reactor to room temperature and depressurization. 50.0 g of polyoxymethylene polymer were added to the reactor and the reactor was re-sealed and purged by pressurization and depressurization with nitrogen. A pressure of 10 bar was then established with nitrogen. The reactor internal temperature was set to 70° C.

10 g of propylene oxide were quickly added to the suspension at an addition rate of 10 g/min (activation). Once addition was complete and after achievement of a constant pressure (time to) the mixture was left until an exothermic reaction in the reactor coupled with a simultaneous pressure drop (time ti) was observable. The time interval between addition (to) and onset of reaction (ti) is hereinbelow referred to as the activation time (t_{act}).

After the exothermic reaction had abated, the remaining amount of propylene oxide (140 g) was added at an addition rate of 3 g/min (semi-batch phase). Once addition was complete the mixture was stirred at 70° C. until the exothermic reaction had abated and until a constant pressure was achieved. The reactor was then cooled and the product withdrawn. The analytical data are reported in table 1. The molar mass distribution is shown in the GPC diagram of FIG. 3.

### Counterexample G1: Production of a Polyoxymethylene-Polyoxyalkylene Block Copolymer Using the Polyoxymethylene Polymer as Starter Material

This example is a comparative example since the ratio of the amount of substance of propylene oxide to the mass of the polyoxymethylene polymer (PO/pFA=1.67) is below the lower limit according to the invention.

A polyoxymethylene-polyoxyalkylene block copolymer was produced according to example 1 but only 50 g of propylene oxide were supplied during the semi-batch phase. After addition of propylene oxide there was a lot of solid in the reaction solution and on the reactor wall and the reaction mixture therefore could not be analyzed.

### Counterexample G2: Production of a Polyoxymethylene-Polyoxyalkylene Block Copolymer Using Commercial Paraformaldehyde (Granuform M)

This example is a comparative example since the molar mass of the paraformaldehyde is not in the range provided for according to the invention.

1400 mg of dried unactivated DMC catalyst were suspended in 200.0 g of 4-methyl-2-oxo-1,3-dioxolane (also referred to hereinafter as cyclic propylene carbonate or cPC) in a 1.0 L pressure reactor. The suspension was heated to 130° C. with stirring (500 rpm). Simultaneously a vacuum was applied for 30 min and the pressure was set to 100 mbar with a constant volume flow of nitrogen through the reactor (vacuum stripping).

Once vacuum stripping was complete the pressure was adjusted to 10 bar with nitrogen and a pulse of propylene oxide (10 g) was added to the reaction solution. Activation of the catalyst was apparent from a temperature increase with a simultaneous pressure drop. The catalyst activation was followed by cooling of the reactor to room temperature and depressurization. 50 g of paraformaldehyde (Granuform M) were added to the reactor and the reactor was re-sealed and purged by pressurization and depressurization with nitrogen. A pressure of 10 bar was then established with nitrogen. The reactor internal temperature was set to 70° C.

50 g of propylene oxide were quickly added to the suspension at an addition rate of 10 g/min (activation). Once addition was complete and after achievement of a constant pressure (time to) the mixture was left until an exothermic reaction in the reactor coupled with a simultaneous pressure drop (time ti) was observable. The time interval between addition (to) and onset of reaction (ti) is hereinbelow referred to as the activation time (t_{act}).

After the exothermic reaction had abated, the remaining amount of propylene oxide (150 g) was added at an addition rate of 3 g/min (semi-batch phase). Once addition was complete the mixture was stirred until the exothermic reaction had abated and until a constant pressure was achieved. The reactor was then cooled and the product withdrawn. The analytical data are reported in table 1. The molar mass distribution is shown in the GPC diagram of FIG. 4.

TABLE 1

| | | | pFA in | MW | MW | |
|---|---|---|---|---|---|---|
| | MW | | polymer | (pFA) | (pFA) | |
| | (g · | | (%) | by NMR | gravim. | t_{act,} |
| No. | mol⁻¹) | PDI | NMR | (g · mol⁻¹) | (g · mol⁻¹) | [min] |
| 1 | 7430.5 | 1.62 | 19.4 | 1442 | 1427 | 120 min |
| 2 | 6759.0 | 1.49 | 23.2 | 1568 | 1298 | 120 min |
| 3 | 8904* | 1.60 | 22.8 | 2030** | 1709** | 70 min |
| G1 | n.d. | n.d. | n.d. | n.d. | n.d. | no |
| | | | | | | activation |
| G2 | 2300* | 1.31 | 18.7 | 430 | 442 | 210 min |

“Starter” refers to polyoxymethylene polymer or paraformaldehyde.
“pFA” refers to polymeric formaldehyde (polyoxymethylene polymer).
“n.d.”: not determined.
*calculated with MW = Mₙ(GPC) · 0.7 (correction factor);
**based on calculated MW of the block copolymer.

1. A process for producing a polyoxymethylene-polyalkylene oxide block copolymer, comprising polymerizing an alkylene oxide in the presence of an OH-terminated polyoxymethylene polymer and a catalyst,
wherein
the polyoxymethylene polymer has a number-average molecular weight Mₙ determined after derivatization with propylene oxide and gel permeation chromatography of ≥1100 g/mol to ≤2300 g/mol with tetrahydrofuran as eluent against polystyrene standards and
the ratio of alkylene oxide to polyoxymethylene polymer is ≥0.05 mol/g.

2. The process as claimed in claim 1, wherein the catalyst comprises a double metal cyanide catalyst.

3. The process as claimed in claim 1, wherein alkylene oxide and polyoxymethylene polymer are present in a weight ratio of alkylene oxide to polyoxymethylene polymer of ≤4.5:1.

4. The process as claimed in claim 1, wherein the polyoxymethylene polymer has an average OH functionality of >1.9.

5. The process as claimed in claim 1, wherein a comonomer other than alkylene oxide is co-used in the reaction.

6. The process as claimed in claim 1, wherein the catalyst comprises a double metal cyanide catalyst (DMC catalyst) and wherein
(i) in a first step the DMC catalyst is activated in the presence of the polyoxymethylene polymer, wherein the DMC catalyst is activated by addition of a sub-amount of an alkylene oxide, and
(ii) in a second step an alkylene oxide is added to the mixture resulting from step (i), wherein the alkylene oxide employed in step (ii) may be identical or different to the alkylene oxide employed in step (i) and
wherein the activation of the DMC catalyst in the first step (i) is carried out at an activation temperature of ≥20° C. to ≤120° C.

7. The process as claimed in claim 6, wherein in the first step (i)
(α) a suspension medium or the polyoxymethylene polymer is initially charged and the suspension medium or polyoxymethylene polymer is dried by removing any water and/or other volatile compounds present, wherein the DMC catalyst is added to the polyoxymethylene polymer or to the suspension medium before or after the drying,
(β) the DMC catalyst is activated in the presence of the polyoxymethylene polymer by addition of a sub-amount of alkylene oxide to the mixture resulting from step (α) and wherein the temperature peak occurring on account of the subsequent exothermic chemical reaction and/or a pressure drop in the reactor is then awaited, and wherein step (β) for activation may optionally be carried out two or more times, and
in the second step (ii)
(γ) an alkylene oxide are added to the mixture resulting from step (β), wherein alkylene oxide employed in step (γ) may be identical or different to alkylene oxide employed in step (β) and wherein at least in one of the steps (α) and (β) at least one polyoxymethylene polymer is added.

8. The process as claimed in claim 7, wherein step (γ) is performed at a temperature of ≥60° C. to ≤70° C.

9. The process as claimed in claim 7, wherein the suspension medium used in step (α) comprises 4 methyl-2-oxo-1,3-dioxolane, 1,3-dioxolan-2-one, acetone, methyl ethyl ketone, acetonitrile, nitromethane, dimethyl sulfoxide, sulfolane, dimethylformamide, dimethylacetamide, N-methylpyrrolidone, dioxane, diethyl ether, methyl tert-butyl ether, tetrahydrofuran, ethyl acetate, butyl acetate, pentane, n-hexane, benzene, toluene, xylene, ethylbenzene, chloroform, chlorobenzene, dichlorobenzene, propylene carbonate, carbon tetrachloride, or a mixture thereof.

10. The process as claimed in claim 7, wherein step (α) comprises:
(α1) initially charging a suspension medium and the DMC catalyst and removing water and/or other volatile compounds by at least once pressurizing the mixture with >1 bar to ≤100 bar (absolute) of an inert gas at a temperature of ≥90° C. to ≤150° C. and in each case subsequently reducing the positive pressure to >1 bar to ≤20 bar (absolute) and in a subsequent step; and
(α2) adding the polyoxymethylene polymer to the mixture from step (α1).

11. A polyoxymethylene-polyalkylene oxide block copolymer obtained by the process as claimed in claim 1.

12. The polyoxymethylene-polyalkylene oxide block copolymer as claimed in claim 11, wherein the polyoxymethylene-polyalkylene oxide block copolymer has a viscosity at 20° C. determined according to DIN 51562 of ≥22,000 mPas to ≤26,000 mPas.

13. The polyoxymethylene-polyalkylene oxide block copolymer as claimed in claim 11, wherein the polyoxymethylene-polyalkylene oxide block copolymer is a polyoxymethylene-polyoxyalkylene carbonate block copolymer comprising an inner polyoxymethylene block and at least one outer polyoxyalkylene carbonate block according to the formula: 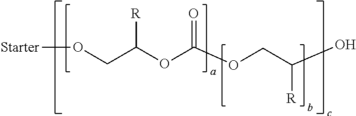
wherein R independently at each occurrence represents an organic radical, a, b and c each represent an integer, each R may be the same or different, the structural unit “starter” represents a polyoxymethylene block derived from the polyoxymethylene polymer and a, b and c are chosen such that the proportion of the “starter” accounts for ≤35% by weight, the proportion of structural units deriving from CO₂ accounts for ≤25% by weight and the proportion of structural units deriving from alkylene oxides accounts for the remainder to 100% by weight in each case based on the total weight of the polymer.

14. A process for producing a polyurethane polymer comprising the step of reacting a polyisocyanate component with a polyol component, wherein the polyol component comprises a polyoxymethylene-polyalkylene oxide block copolymer as claimed in claim 11.

15. A polyurethane polymer obtained by the process as claimed in claim 14.
